(19) United States
(12) Patent Application Publication
(10) Pub. No.: US 2006/0105287 A1
(43) Pub. Date: May 18, 2006

(54) Do-it-yourself orthodontic kit and method

(76) Inventor: Judith Alane Wilburn, Belmont, MA (US)

Correspondence Address: LAW OFFICE OF A.P. DURIGON, 20 EUSTIS STREET, CAMBRIDGE, MA, 02140, US

(21) Appl. No.: 11/162,804

(22) Filed: Sep. 23, 2005

Related U.S. Application Data
(63) Continuation-in-part of application No. 10/987,711, filed on Nov. 15, 2004.

(51) Int. Cl. A61C 3/00

(52) U.S. Cl. 433/24; 433/6

(57) ABSTRACT

The do-it-yourself orthodontic kit and method of the present invention is a tooth straightening kit utilizing a simple and economical process of straightening teeth that does not require assistance or application by a professional such as a dentist. A dental positioner is constructed by first forming an impression of an individual's upper or lower dentition then casting a temporarily adjustable plastic cast from the impression. Corrections are made to the position of individual teeth on the cast model. A low-melting-point plastic is softened, hand-molded over the corrected cast, and removed when cool. User wears resulting device to reposition crooked teeth.

### CROSS-REFERENCE TO RELATED APPLICATIONS

This invention is a continuation-in-part of co-pending U.S. non-provisional application Ser. No. 10/987,711, filed Nov. 15, 2004 of the same inventive entity as herein, incorporated herein by reference.

### FIELD OF THE INVENTION

The invention relates to the field of orthodontia, specifically to a do-it-yourself orthodontic kit and method.

### BACKGROUND OF THE INVENTION

The principles of correcting teeth alignment with pressure are old, mostly involving wire braces worn with incremental adjustment, with a plastic retainer (as described by Bergersen, 1975, U.S. Pat. No. 3,950,851) worn to maintain the final alignment. Tooth positioners for finishing orthodontic treatment are described by Kesling in the Am. J. Orthod. Oral. Surg. 31:297-304 (1945) and 32:285-293 (1946). Subsequent innovations have used some version of a plastic retainer/positioner to effect a change in tooth alignment to a pre-determined position, over time. Andrews describes an improved orthodontic positioner in 1984 U.S. Pat. No. 4,591,341; Martz specifies a device that allows for a patient's ability to insert and remove positioner in 1988, U.S. Pat. No. 4,793,803; Breads describes creating a positioner from a corrected model in 1986, U.S. Pat. No. 4,856,991. The manufacture of orthodontic positioners is also described in U.S. Pat. Nos. 5,186,623; 5,059,118; 5,055,039; 5,035,613; 4,798,534; 4,755,139; and 6,485,298.

All of the above require a dental professional to devise a treatment plan and create a device(s). The present invention is a tooth straightening means utilizing a simple and economical process of repositioning teeth that does not require assessment, treatment or assistance by a professional such as a dentist. It allows identification and correction of maloccluded teeth by a non-professional, using unsophisticated tools and materials to create a semi-rigid tooth positioner in a non-laboratory environment.

### SUMMARY OF THE INVENTION

It is one object of the present to disclose a do-it-yourself method of tooth straightening.

It is a related object of the present invention to disclose a do-it-yourself orthodontic kit.

The do-it-yourself method of tooth straightening of the present invention includes the steps of:

creating a negative dental impression of the dental arch, by pouring an alginate and water mixture into a dental tray to form a semisolid matrix and biting into the matrix to create a negative dental impression of the dental arch;

creating a positive model of the dental arch from the negative dental impression, by pouring a quick setting thermosettable material into the negative dental impression to fill impressions therein made in the biting substep and removing the thermosetting material which bears a positive dental impression of the teeth to thereby provide a positive model of the dental arch;

creating an ideal dental arch, by cutting around an irregular tooth of the positive model of the dental arch, incrementally changing the position of the cut around irregular tooth so as to provide an ideal dental arch, allowing the ideal dental arch to fully solidify, and coating the ideal dental arch with lubricant; and

creating a retainer, by softening plastic in warm water, rolling the softened plastic while still warm into a generally cylindrical shape, placing the same onto the inside surface of the ideal dental arch by molding the plastic over the entire surface of the ideal arch so that all surfaces are covered with a layer of plastic which forms a molded shell, and releasing the molded shell after it has cooled from the ideal dental arch to form a retainer.

Preferably, the pouring substep of said positive model creating step is accomplished by pouring a curable casting resin; said cutting substep of said ideal dental arch creating step is accomplished by cutting around the irregular tooth to the gum line; said incrementally changing substep of said ideal arch creating step is accomplished by holding the positive impression with one hand so as to stabilize it and by using the thumb and fingers of the other hand to force the cut irregular tooth into a better, more ideal position; said layer of plastic of said retainer creating step is between one (1) mm and three (3) mm in thickness; and said molded shell of said retainer creating step is released after it has been allowed to cool to a temperature of no more than 30 degrees C.

The do-it-yourself orthodontic kit of the present invention comprises:

(a) first components that are usable to provide an actual dental impression of the arch to be straightened, said first components including:
(i) a dental tray;
(ii) a semisolid matrix material that may be poured into the dental tray for use in providing a negative dental impression;
(iii) a curable matrix to provide, from the negative dental impression, a positive dental impression;

(b) second components that are usable to provide an ideal arch from the positive dental impression, said second components including:
(i) a saw adapted to cut the positive dental impression to allow manual re-formation of a tooth in the area of the cut to provide an ideal dental arch; and

(c) third components for creating a retainer from the ideal arch, said third components including:
(i) non-toxic plastic material sofenable in warm water of quantity sufficient to be rolled into a generally cylindrical shape for application to and subsequent removal from the ideal dental arch in order to provide a retainer for use in straightening the teeth of the wearer of the retainer.

Preferably, the semisolid matrix of said first components includes alginate; the curable matrix of said first components includes a quick setting thermoset liquid plastic casting compound; said second components further include a lubricant for application to the ideal arch; said non-toxic plastic material of said third components has a low melting temperature such that it can be molded by hand when maintaining an internal temperature between seventy to one hundred (70-100) degrees C. and becomes semirigid at an internal temperature of less than sixty (60) degrees C.; and said quantity of said non-toxic plastic material of said third components is between about ten to fifteen (10-15) cc.

### BRIEF DESCRIPTION OF THE DRAWING

Other objects, inventive aspects and advantageous features of the present invention will become apparent as the invention becomes better understood by referring to the following solely exemplary detailed description of the invention, and to the drawings, wherein:

FIG. 1 shows the user cutting the model to isolate the tooth to be moved;

FIG. 2 shows the user correcting the alignment of a tooth on the model;

FIG. 3 shows the user molding the pliable plastic mass over the hardened model;

FIG. 4 shows the plastic covering the model; and

FIG. 5 shows the hardened positioner being removed from the model.

### DETAILED DESCRIPTION OF THE INVENTION

This invention provides a do-it-yourself orthodontic kit and appliance for realigning maloccluded teeth using the various components supplied by the do-it-yourself orthodontic kit by employing the following method of construction of the appliance and wearing the same to straighten the teeth. The components of the kit enable to practice the method of straitening teeth and the method is able to be practiced by the various components of the kit. The user makes an impression of his teeth using standard dental equipment and supplies. Typically this involves mixing dental alginate and water to form a semisolid matrix which will hold an imprint of the dental arch and biting into it to create a negative impression of the entire dental arch.

A model of the teeth is created using a quick-setting thermoset liquid plastic casting compound, wherein the casting compound comprises quick-setting ultra-low viscosity casting resins that possess an interim pliable state followed by a rigid state. The liquid compound is poured into the toothmarks in the alginate impression, completely filling and covering all impression cavities in the alginate. When the casting compound is firm but still pliable, the model is removed from the impression matrix and laid on a firm surface.

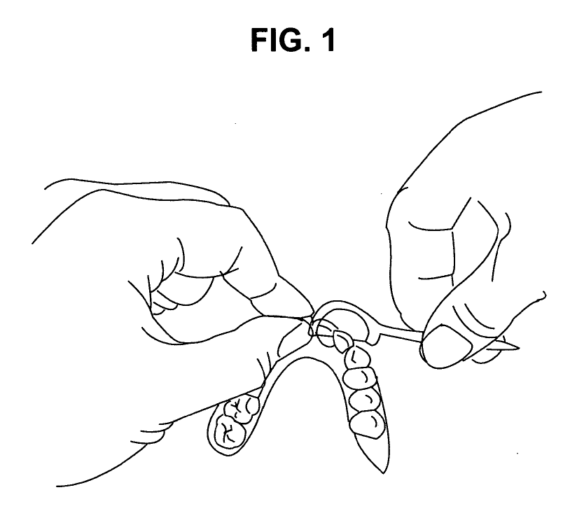

Using a finely serrated blade or saw, the crooked tooth is isolated by cutting through the plastic separating the tooth to be straightened from its neighbors. FIG. 1 is a perspective view of a user isolating a tooth on the model of the dental arch. Cuts should be made on both sides of the tooth to the point where it meets the gum line.

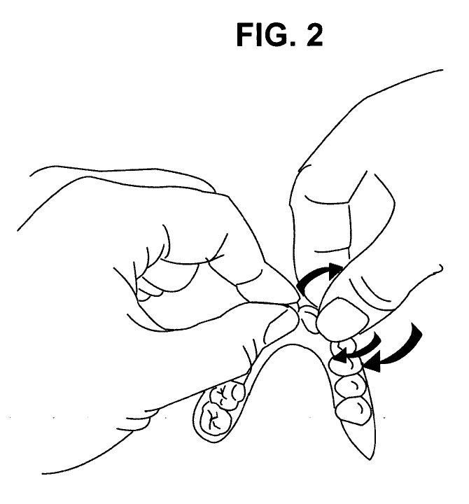

Being careful not to distort the shape of the whole, the user steadies the model with one hand and with the other grasps the tooth isolated in the previous step. FIG. 2 is a perspective view of a user changing the relative position of a tooth on the model of the dental arch. Holding the isolated tooth between thumb and finger, the user twists or pushes it into closer alignment with its neighbors. The degree of correction should be small, consisting of a change no more than a millimeter's distance or a 5-degree rotation from its original alignment. The changes made must be slight and must affect only one or two teeth. Anything more significant will result in an appliance that will not fit the user's mouth. The model is then set aside to complete the curing process and become completely hard. When completely hard, the user lightly coats the entire surface of the model with non-toxic lubricant, such as petroleum jelly.

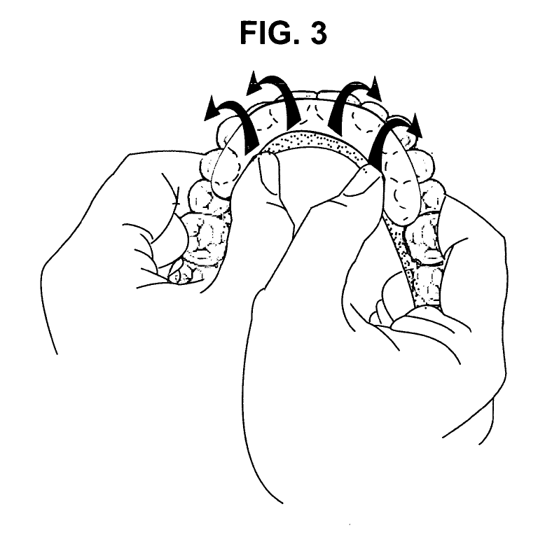

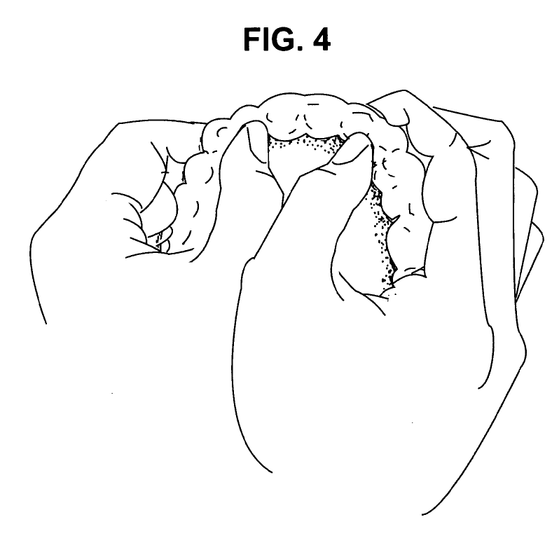

The user then takes a small amount (10-15 cubic centimeters or 15-20 grams) of a non-toxic plastic with a low melting temperature such that it can be molded by hand when maintaining an internal temperature between 70-100 degrees C. and becomes semi rigid at an internal temperature of less than 60 degrees C. The plastic is softened in warm (70° C.-100° C.) water. When completely pliable, it is removed from the warm water and formed into a cylinder about 6 cm in length by about 1 cm in diameter. Placing the cylinder on the inner curve of the corrected tooth model, the user molds the compound over the entire surface of the dental facsimile, working the material forward with his hands, such that all or most or the tooth surfaces are covered with a layer of plastic between 1 mm and 3 mm in thickness. FIG. 3 is a perspective view of a user modeling a softened mass of non-toxic plastic modeling material over the corrected dental model. FIG. 4 is a view of the dental facsimile surface once the modeling compound has been smoothed to a uniform thickness ranging from 1 mm to 3 mm in depth.

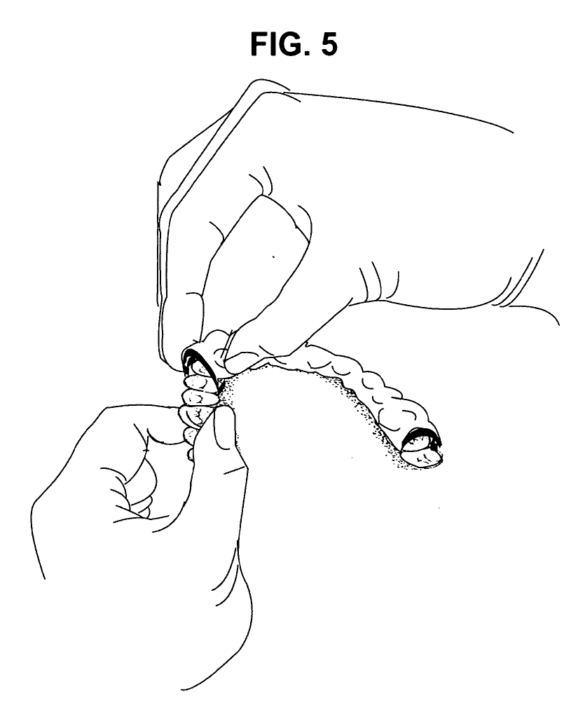

When thoroughly cooled to a temperature of no more than 30° C., the plastic shell is pried from the model. FIG. 5 is a perspective view of a user removing the cooled modeling compound from the dental facsimile. The resulting plastic shell comprises a dental positioner that will fit over the user's actual teeth. This semi-rigid shell will serve as a dental positioner that will apply pressure to the crooked tooth, easing it into the corrected position when worn at least 8 hours a day for a period between one week and several months. Subsequent corrections can be made by repeating the entire process.

Many modifications of the present invention become apparent without departing from the inventive concepts.

What is claimed is:

1. A do-it-yourself method of tooth straightening, comprising the steps of:
creating a negative dental impression of the dental arch, by pouring an alginate and water mixture into a dental tray to form a semisolid matrix and biting into the matrix to create a negative dental impression of the dental arch;
creating a positive model of the dental arch from the negative dental impression, by pouring a quick setting thermosettable material into the negative dental impression to fill impressions therein made in the biting substep and removing the thermosetting material which bears a positive dental impression of the teeth to thereby provide a positive model of the dental arch;
creating an ideal dental arch, by cutting around an irregular tooth of the positive model of the dental arch, incrementally changing the position of the cut around irregular tooth so as to provide an ideal dental arch, allowing the ideal dental arch to fully solidify, and coating the ideal dental arch with lubricant;
creating a retainer, by softening plastic in warm water, rolling the softened plastic while still warm into a generally cylindrical shape, placing the same onto the inside surface of the ideal dental arch by molding the plastic over the entire surface of the ideal arch so that all surfaces are covered with a layer of plastic which forms a molded shell, and releasing the molded shell after it has cooled from the ideal dental arch to form a retainer.

2. The do-it-yourself method of tooth straightening of claim 1, wherein said pouring substep of said positive model creating step is accomplished by pouring a curable casting resin.

3. The do-it-yourself method of tooth straightening of claim 1, wherein said cutting substep of said ideal dental arch creating step is accomplished by cutting around the irregular tooth to the gum line.

4. The do-it-yourself method of tooth straightening of claim 1, wherein said incrementally changing substep of said ideal arch creating step is accomplished by holding the positive impression with one hand so as to stabilize it and by using the thumb and fingers of the other hand to force the cut irregular tooth into a better, more ideal position.

5. The do-it-yourself method of tooth straightening of claim 1, wherein said layer of plastic of said retainer creating step is between one (1) mm and three (3) mm in thickness.

6. The do-it-yourself method of tooth straightening of claim 1, wherein said molded shell of said retainer creating step is released after it has been allowed to cool to a temperature of no more than 30 degrees C.

7. A do-it-yourself orthodontic kit, comprising:
(a) first components that are usable to provide an actual dental impression of the arch to be straightened, said first components including:
(i) a dental tray;
(ii) a semisolid matrix material that may be poured into the dental tray for use in providing a negative dental impression;
(iii) a curable matrix to provide, from the negative dental impression, a positive dental impression;
(b) second components that are usable to provide an ideal arch from the positive dental impression, said second components including:
(i) a saw adapted to cut the positive dental impression to allow manual re-formation of a tooth in the area of the cut to provide an ideal dental arch; and
(c) third components for creating a retainer from the ideal arch, said third components including:
(i) non-toxic plastic material sofenable in warm water of quantity sufficient to be rolled into a generally cylindrical shape for application to and subsequent removal from the ideal dental arch in order to provide a retainer for use in straightening the teeth of the wearer of the retainer.

8. The do-it-yourself orthodontic kit of claim 7, wherein said semisolid matrix of said first components includes alginate.

9. The do-it-yourself orthodontic kit of claim 7, wherein said curable matrix of said first components includes a quick setting thermoset liquid plastic casting compound.

10. The do-it-yourself orthodontic kit of claim 7, wherein said second components further include a lubricant for application to the ideal arch.

11. The do-it-yourself orthodontic kit of claim 7, wherein said non-toxic plastic material of said third components has a low melting temperature such that it can be molded by hand when maintaining an internal temperature between seventy to one hundred (70-100) degrees C. and becomes semirigid at an internal temperature of less than sixty (60) degrees C.

12. The do-it-yourself orthodontic kit of claim 7, wherein said quantity of said non-toxic plastic material of said third components is between about ten to fifteen (10-15) cc.
